(19) United States
(12) Patent Application Publication
(10) Pub. No.: US 2015/0188179 A1
(43) Pub. Date: Jul. 2, 2015

(54) METHOD FOR MANUFACTURING END PLATE FOR FUEL CELL STACK

(71) Applicants: HYUNDAI MOTOR COMPANY, Seoul (KR); DAEWON KANG UP CO., LTD., Cheonan (KR)

(72) Inventors: Jung Do Suh, Seoul (KR); Yong Suk Heo, Seoul (KR); Back Nam Kim, Seoul (KR); Jae Cheon Lee, Bucheon (KR); Jin Yong Park, Incheon (KR)

(21) Appl. No.: 14/511,584

(22) Filed: Oct. 10, 2014

(30) Foreign Application Priority Data
Dec. 31, 2013 (KR) 10-2013-0168313

(51) Int. Cl. H01M 8/24

(52) U.S. Cl. CPC H01M 8/248

(57) ABSTRACT

A method of manufacturing an end plated for a fuel cell stack, using overmolding injection molding is provided. The method prevents damage to tapped portions in injection molding and re-tapping after the injection molding, by implementing a method of injection molding for an end plate that prevents an injection-molded part from flowing into taps by forming a male thread on a first side of each of fixing pins fitted in a metal insert in injection molding of an end plate and by fastening the fixing pins in advance in the taps of the metal insert. In addition, the method aligns the metal insert at the more accurate position while a mold is assembled, by tapering the second sides of the fixing pins.

### CROSS-REFERENCE TO RELATED APPLICATION

This application claims under 35 U.S.C. §119(a) the benefit of Korean Patent Application 10-2013-0168313 filed on Dec. 31, 2013, the entire contents of which are incorporated herein by reference.

### BACKGROUND

(a) Technical Field

The present disclosure relates to a method for manufacturing an end plate for a fuel cell stack, and more particularly, to a method of manufacturing an end plate used for a fuel cell stack, using injection molding.

(b) Background Art

In general, an electrode membrane is positioned within fuel cell stacks and is composed of a solid polymer electrolyte membrane that can carry hydrogen quanta and catalytic layers coated on both sides of the electrolyte membrane to allow for reaction of hydrogen and oxygen, that is, a cathode and an anode. Further, a gas diffusion layer and a gasket etc. are stacked on the outer sides of the electrolyte membrane, that is, the outer sides with the cathode and the anode thereon, a bipolar plate with channels that supply fuel and discharging water produced by a reaction is disposed on the outer side of the gas diffusion layer, and an end plate that supports the components is attached to the outermost side. Accordingly, at the anode of the fuel cell, an oxidation reaction of hydrogen occurs and hydrogen ions and electrons are produced, and the hydrogen ions and the electrons move to the cathode through the electrolyte membrane and the bipolar plate.

Additionally, at the cathode, water is produced by an electrochemical reaction of the hydrogen ions and electrons, which moved from the anode, and oxygen in the air, and electric energy is generated by the flow of the electrons. In the fuel cell stack having the above configuration and operation, the end plate supports the components to maintain surface pressure substantially uniform in the stack. In other words, the function of the end plate that supports the components to maintain surface pressure substantially uniform in the stack determines the function of the stack in association with preventing leakage of fluid in the stack and preventing an increase in electric contact resistance between the cells.

The end plate, which is a thick plate-shaped part that supports both ends of the stack, is composed of a metal insert 10, a plastic cover 11, and a current collector 12, as shown in FIG. 3. In addition, M6 and M5 taps 13 are formed at the sides of the end plate to insert substantially long bolts for handling (e.g., carrying) the stack, or to fix other parts such as the parts for measuring voltage when the stack is mounted within a vehicle. The end plate is manufactured through the processes of shaping of a metal insert, tapping, and injection molding of a plastic cover.

For example, an overmolding injection mold for manufacturing an end plate, as shown in FIG. 4, is composed of a cope 14, a drag 15, and four slide cores 16. The end plate is manufactured through a process of mounting the metal insert 10 into the drag 15, a process of combining the cope 14, the drag 15, and the slide cores 16 (in which fixing pins mounted in advance on the slide cores are fitted into the taps 13 of the metal insert 10), and injection molding that covers the metal insert 10 with the plastic cover 11. In other words, manufacturing of an end plate for a fuel cell stack is composed of placing a metal insert into a mold and applying an insulation function by injection-molding a polymer.

In the related art, however, since the pins for fixing a metal insert are mounted on slide cores, in many cases, the molten metal of a polymer flows into the apertures of an end plate (e.g., taps in the metal insert) in injection molding, and accordingly, tapping is required to be repeated after the injection molding. Further, when the metal insert is not at an accurate position within a mold, the fixing pins may damage the tapped portions of the end plate in the process of assembling the mold. In other words, as shown in FIG. 5, the slide cores 16 and the fixing pins 17 are forcibly fitted or thread-fastened, and thus the joints of the fixing pins 17 and the metal insert 10 may be damaged in assembling of the mold. For example, unless the metal insert 10 is at the accurate position in the process of assembling the mold for injection molding, the fixing pins 17 and the taps 13 may be damaged. Further, tapping is required to be performed again after injection molding due to the injection-molded part sticking in the gaps between the fixing pins 17 and the taps 13 in the injection molding.

The above information disclosed in this section is merely for enhancement of understanding of the background of the invention and therefore it may contain information that does not form the prior art that is already known in this country to a person of ordinary skill in the art.

### SUMMARY

Accordingly, the present disclosure provides a method of manufacturing an end plate for a fuel cell stack which may prevent damage to tapped portions in injection molding and of re-tapping after the injection molding, by implementing a method of injection molding for an end plate that prevents an injection-molded part from flowing into taps by forming a male thread on a side of each of fixing pins fitted in a metal insert in injection molding of an end plate and by fitting the fixing pins in advance in the taps of the metal insert, and that aligns the metal insert at the accurate position while a mold is assembled, even when the metal insert is not positioned at the accurate position in the mold by tapering the other sides of the fixing pins.

The method of manufacturing an end plate for a fuel cell stack may include: mounting a metal insert onto a drag; combining a cope, the drag, and four slide cores; injecting polymer molten metal into the mold with the metal insert therein; and separating the mold and ejecting an end plate with the metal insert covered with a plastic cover. In particular, in the mounting of a metal insert, the metal insert may be mounted with fixing pins having a male-threaded portion, fitted to the taps before the metal insert is mounted. Therefore, according to the method of manufacturing an end plate for a fuel cell stack, it may be possible to prevent an injection-molded part from flowing into the tapped portions of an end plate and automatically retain a metal insert at the accurate position in a mold.

The combining of a cope, a drag, and four slide cores may include retaining the metal insert at the accurate position when the mold and the cores are combined, even when the metal insert is not disposed at the accurate position, by using the tapered shape the front end portions of the fixing pins fitted to the metal insert. In the mounting of a metal insert, the fixing pins fitted to the tap of the metal insert may be seated onto fixing pin guides on the drag to automatically retain the metal insert. The method of manufacturing an end plate for a fuel cell stack provided by the present disclosure has the following advantages.

First, a metal insert may be automatically retained in a mold by tapered fixing pins.

Second, an injection-molded part may be prevented from flowing into tapped portions of the metal insert by the fixing pins fitted to the metal insert.

Third, the gaps between the slide cores and the fixing pins may be minimized and an injection-molded part flowing into the gaps may be prevented by the tapered fixing pins.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present invention, and wherein:

FIG. 1 is an exemplary view showing a structure for fitting fixing pins to a metal insert in a method of manufacturing an end plate for a fuel cell stack according to an exemplary embodiment of the present invention;

FIG. 2 is an exemplary view showing the arrangement relationship of a metal insert with fixing pins, a mold, and slide cores in a method of manufacturing an end plate for a fuel cell stack according to an exemplary embodiment of the present invention;

FIG. 3 is an exemplary view and a cross-sectional view showing the components of a common end plate according to the related art;

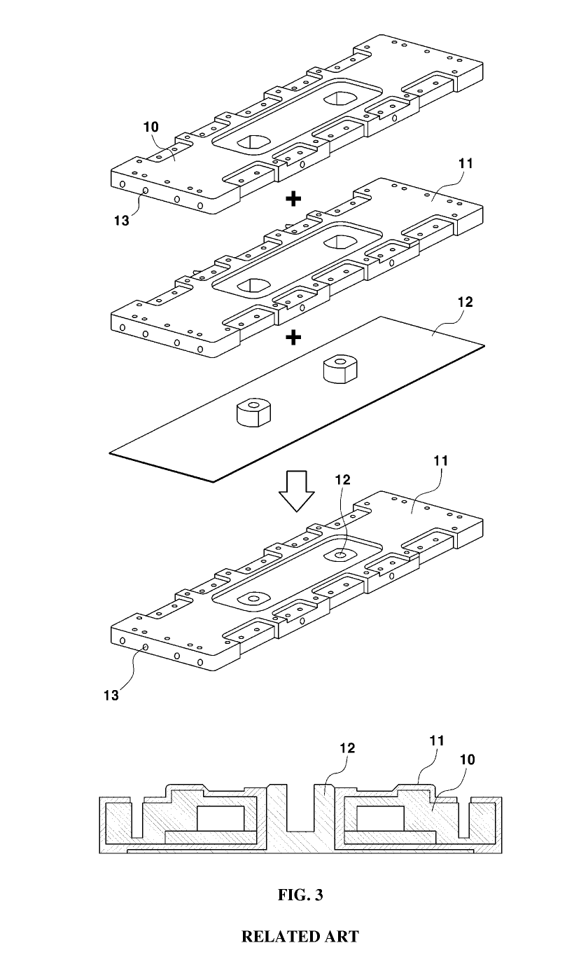

FIG. 4 is an exemplary view showing the arrangement relationship of a metal insert, slide cores with fixing pins, and a mold in injection molding of an end plate of the related art; and

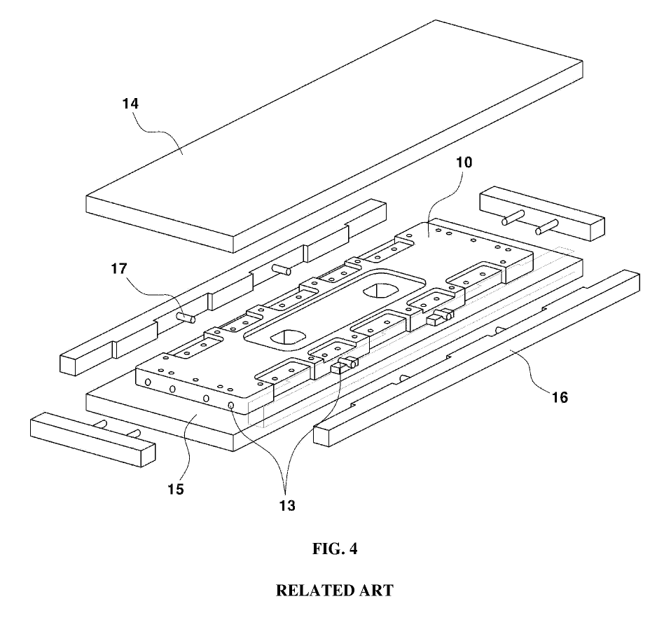

FIG. 5 is and exemplary view showing the coupling structure of the slide cores, fixing pins, and metal insert in injection molding of an end plate of the related art.

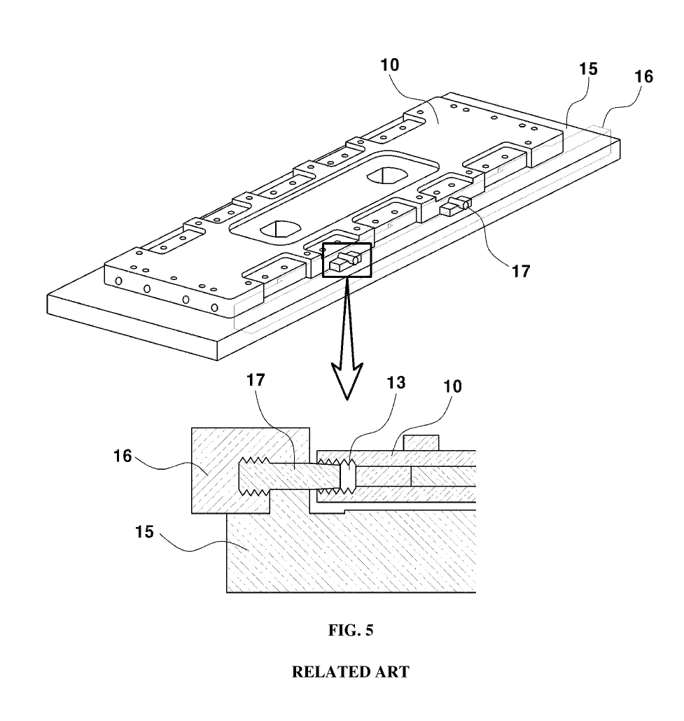

| | |
|---|---|
| 10: metal insert | 11: plastic cover |
| 12: current collector | 13: tap |
| 14: cope | 15: drag |
| 16: slide core | 17: fixing pin |
| 18: male-threaded portion | 19: tapered portion |
| 20: retaining aperture | 21: fixing pin guide |

It should be understood that the appended drawings are not necessarily to scale, presenting a somewhat simplified representation of various features illustrative of the basic principles of the invention. The specific design features of the present disclosure as disclosed herein, including, for example, specific dimensions, orientations, locations, and shapes will be determined in part by the particular intended application and use environment. In the figures, reference numbers refer to the same or equivalent parts of the present disclosure throughout the several figures of the drawing.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the present disclosure is described in detail with reference to the accompanying drawings.

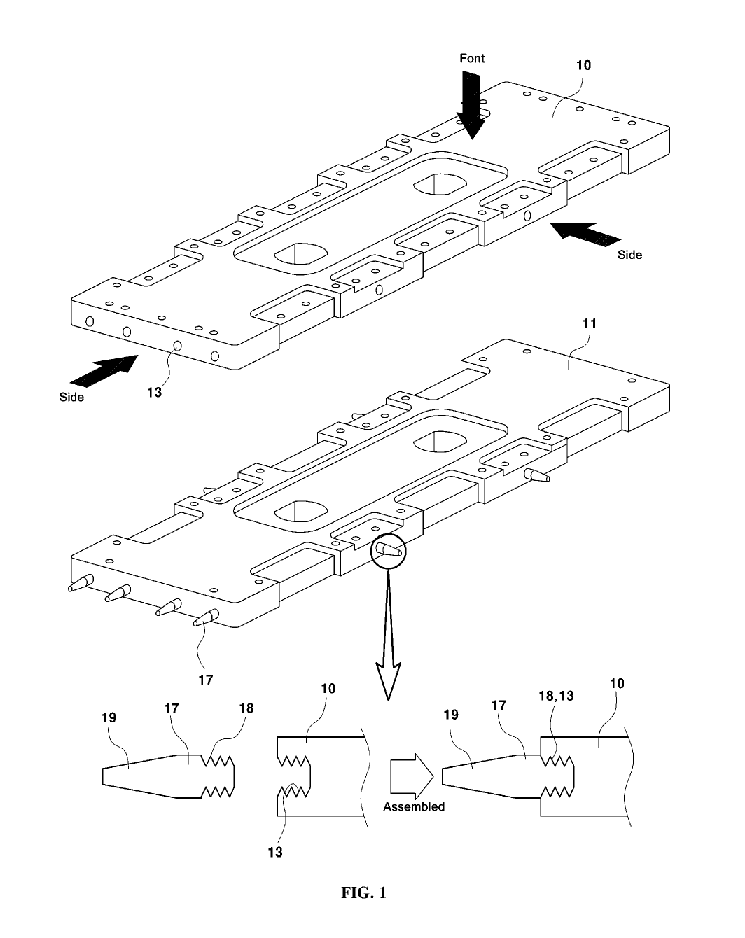

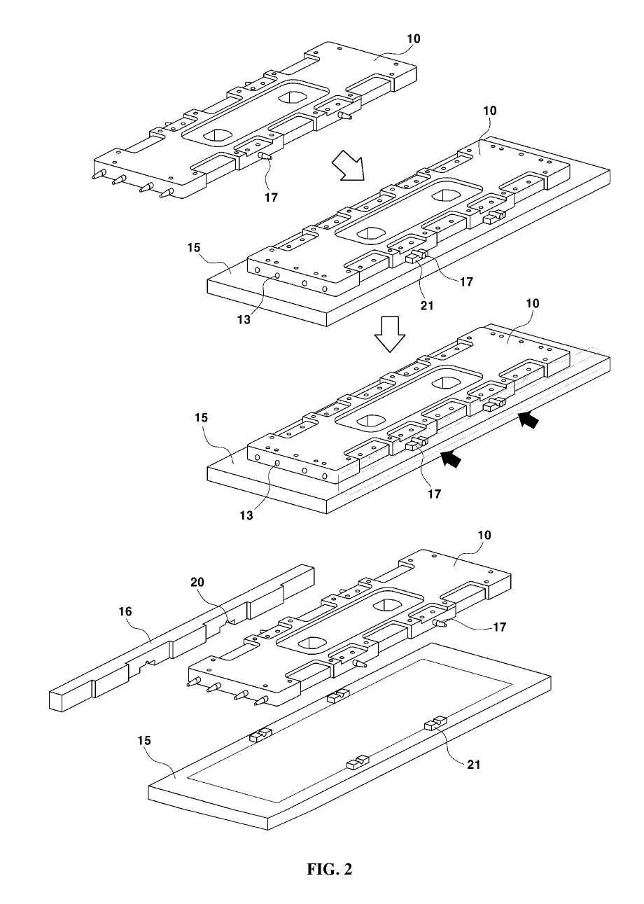

FIG. 1 is an exemplary view showing a structure for fitting fixing pins to a metal insert in a method of manufacturing an end plate for a fuel cell stack according to an exemplary embodiment of the present disclosure and FIG. 2 is an exemplary view showing the arrangement relationship of a metal insert with fixing pins, a mold, and slide cores in a method of manufacturing an end plate for a fuel cell stack according to an exemplary embodiment of the present invention. As shown in FIGS. 1 and 2, a method of manufacturing an end plate for a fuel cell stack may prevent an injection-molded part flowing in tapped portions of an end plate and may more easily retain a metal insert at a more accurate position in a mold, by including mounting a metal insert with fixing taps, which has a tapered front end portion and a male-threaded rear end portion, fitted in advance, into a mold.

Accordingly, fixing pins 17 having a tapered portion 19 at a front end portion and a male-threaded portion 18 at a rear end portion may be fixed using the male-threaded portions 18 fitted to taps 13 formed around the edge of a metal insert 10. The fixing pins 17 may be selectively fitted to appropriate male-threaded portions 18 of a plurality of taps 13 formed around the edge of the metal insert 10. For example, the fixing pins may be substantially uniformly fit and two fixing pins may be fit on each of the longer sides and four fixing pins may be fit on each of the shorter sides of the metal insert 10 formed in a substantially rectangular shape. The male-threaded portions 18 of fixing pins 17 fitted to the taps 13 of the metal insert 10 may close the tap apertures, as described above, to prevent an injection-molded part from flowing into the tap apertures.

Since the front end portion of the fixing pin 17 that is fitted to the tap 13 of the metal insert 10 may be tapered, that is, is the tapered portion 19, the fixing pin 17 may be inserted into a retaining aperture 20 formed on a slide core 16 while adjusting the position of the fixing pin 17 using the tapered portion 19, the fixing pin 17 is inserted into the retaining aperture 20 in assembling of a mold, particularly, in combining of the slide core 16, even when the metal insert 10 is not at an accurate position. In other words, the metal insert 10 may be maintained at the accurate position in a drag 15 by the fixing pins 17 inserted into the retaining apertures 20 of the slide cores 16 while being positioned using the tapered portions 19 when a mold is assembled.

Further, fixing pin guides 21 configured to retain the fixing pins 17 may be formed around the edge on the top of the drag 15. The fixing pin guide 21 may be formed in the shape of a rectangular block with a groove having an arc cross-section configured to receive the fixing pin 17, on the top, to seat the fixing pin 17 with a portion in the groove. A plurality of fixing pin guides 2 may be arranged with regular intervals along the edge of one side, the edges of both sides, or the edges of four sides of the drag 15, for example, to correspond to the number and position of the fixing pins 17 on the metal insert 10.

Accordingly, when the metal inset 10 is mounted on the mold, the metal inset 10 may be retained at a more accurate position by the fixing pins 17 seated onto the fixing pin guides 21 and retained at the more accurate position by the fixing pins 17 inserted into the apertures of the slide core 16 using the tapered portion 19 when the cope, the drag, and the slide cores are combined, to mount the metal insert 10 at the more accurate position inside the drag 15.

A method of manufacturing an end plate, using this configuration, is described step by step hereafter. First, the process may include inserting the male-threaded portions of fixing pins into taps of the metal insert and then mounting the metal insert with the fixing pins inserted onto a drag, before mounting the metal insert onto the drag. The metal insert may be primarily retained at a more accurate position by seating the fixing pins fitted to the taps of the metal insert onto fixing pin guides on the drag.

Further, of the process may include combining the cope, the drag, and four slide cores. When the metal insert is not at the more accurate position, is the metal insert may be secondarily retained at the more accurate position while the fixing pins fitted to the metal insert are inserted into the slide cores through the tapered front end portions, that is, the metal insert may be arranged at the more accurate position in the mold while being retained twice by the fixing pins and the tapered portions. Additionally, the process may include injecting polymer-molten metal into the mold with the mold and the slide core combined and the metal insert at the more accurate position. The mold may then be separated and an end plate may be ejected (e.g., removed from the mold) with the metal insert covered with a plastic cover after injecting the molten metal, and thereafter, the fixing pins fitted to the end plate may be removed, thereby completing an end plate product and finishing the process for manufacturing an end plate.

As described above, since the present disclosure implements an overmolding injection-molding method including a process of fitting fixing pins, which have a male-threaded shape at a side (e.g., a first side) and a tapered shape on the other side (e.g., a second side), to a metal insert and then mounting the metal insert into a mold, it may be possible to preclude inefficiency such as re-tapping due to an injection-molded part flowing in tap apertures or damage to the taps of an end plate by fixing pins, as in the related art. Therefore, it may be possible to increase efficiency of the process of manufacturing an end plate and secure the quality of the end plate product.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A method of manufacturing an end plate for a fuel cell stack, the method comprising:
mounting a metal insert onto a drag;
combining a cope, the drag, and four slide cores;
injecting polymer molten metal into the mold with the metal insert therein; and
separating the mold and removing an end plate with the metal insert covered with a plastic cover,
wherein in the mounting of a metal insert, the metal insert is mounted with fixing pins having a male-threaded portion and fitted to taps of the metal insert before the metal insert is mounted.

2. The method of claim 1, wherein the mounting of a metal insert includes:
automatically retaining the metal insert by seating the fixing pins fitted to the taps of the metal insert onto fixing pin guides on the drag.

3. The method of claim 2, wherein the combining of a cope, a drag, and four slide cores includes:
retaining the metal insert at a more accurate position when the mold and the cores are combined, using the tapered shape the front end portions of the fixing pins fitted to the metal insert.
